(19) United States
(12) Patent Application Publication
(10) Pub. No.: US 2021/0060365 A1
(43) Pub. Date: Mar. 4, 2021

(54) FireCoat FEDS (Fullbody Emergency Descent System)

(71) Applicant: Norman E. Wood, Cameron, WV (US)

(72) Inventor: Norman E. Wood, Cameron, WV (US)

(21) Appl. No.: 16/894,393

(22) Filed: Jun. 5, 2020

Related U.S. Application Data
(63) Continuation-in-part of application No. 15/458,003, filed on Mar. 13, 2017, now abandoned.
Application No. 15/458,003 is a continuation-in-part of application No. 14/279,268, filed on May 15, 2014, now abandoned.
(60) Provisional application No. 61/824,058, filed on May 16, 2013.

(51) Int. Cl. A62B 35/00; A62B 17/00; A62B 1/14

(52) U.S. Cl. CPC A62B 35/0018; A62B 1/14; A62B 17/003

(57) ABSTRACT

A full body emergency descent system (EDS) for incorporating into a firefighter's coat and pants set outside the interior heat protective barrier liner for said coat and pants to enable safe descent from elevated heights in an emergency. The EDS includes: a panel housing a section of continuous flame resistant rope wrapped vertically between a plurality of horizontally extending elastic loops. The panel also includes a pair of chest straps stored in the coat interior until needed and left and right leg straps with buckles that connect to matching buckles in the lower coat interior for forming a full body harness with both upper and lower harness portions.

### CROSS-REFERENCE TO RELATED APPLICATIONS

This application is a continuation-in-part of application Ser. No. 15/908,550, filed on Feb. 28, 2018, which is a continuation-in-part of application Ser. No. 15/458,003, filed on Mar. 13, 2017, which was a continuation-in-part of application Ser. No. 14/279,268, filed on May 15, 2014, now abandoned. The latter was a perfection of Provisional Application Ser. No. 61/824,058, filed on May 16, 2013. All of the foregoing disclosures are incorporated by reference herein.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable.

### BACKGROUND OF THE INVENTION

### (1) Field of the Invention

The present invention relates to an emergency descent system, or “EDS”. More particularly, this invention relates to an EDS that can be fully incorporated, both storage and during use, in the outerwear of a firefighter's gear, especially the coat and pants for the same. These lightweight, integral systems will be “available” any and every time thereby allowing its wearer to safely escape from the higher levels of a building, home or office in an atypical emergency. This invention uses flame resistant rope or cable for lowering each firefighting individual to affect a controlled descent from a higher to lower elevation.

### (2) Description of Related Art Including Information Disclosed Under 37 CFR 1.97 and 1.98

Descent control devices have been developed with the objective of lowering individuals (or objects) from a higher to lower elevation. Such devices have taken many forms and have utilized a variety of elements. Some are capable of providing a mechanical braking mechanism, such as a dead-man or panic control feature, when the device would be used for descent, escape, or rescue purposes.

Concerns with occupational safety have led to the development of mechanisms that enable a worker to lower himself from an elevated position such as a scaffold, crane, lift truck or platform in the event of an emergency. That equipment is, in some respects, similar to known fire escape devices, mountain climbing equipment, and military equipment.

One descent control device with a dead-man brake, in the form of a vertical cylindrical drum or capstan about which a rope is wound and a tapered slot through the drum for receiving and releasably gripping the rope, is shown in Varner et al. U.S. Pat. No. 4,883,146. That device includes plates on each end of a vertical cylindrical drum or capstan with apertures on each end plate through which the rope is threaded, then wound in two or more turns around the drum.

Tapered slots are well known for releasably fastening ropes, lines and cables. The use of cylindrical capstans for holding and providing a mechanical advantage for tightening ropes is also known. Likewise, a variety of fire escape devices utilize rope wound around a cylinder. See, for example, Budd U.S. Pat. No. 386,237; FitzGerald U.S. Pat. No. 536,866; Howe U.S. Pat. No. 771,251; Thuemer U.S. Pat. No. 946,588; Smith U.S. Pat. No. 1,115,603; Steffen U.S. Pat. No. 4,311,218; and Forrest U.S. Pat. Nos. 4,508,193 and 4,550,801.

In addition, there are known but clearly distinguishable teachings in Hobbs U.S. Pat. No. 3,678,543; Arancio U.S. Pat. No. 3,738,449; Wagner U.S. Pat. No. 4,019,609; Bell et al. U.S. Pat. No. 4,714,135; Varner et al. U.S. Pat. Nos. 5,038,888 and 5,131,491; Bassett U.S. Pat. No. 6,131,697; Harbers Jr. U.S. Pat. No. 6,585,082; Metz U.S. Pat. No. 6,817,443; Henson U.S. Pat. No. 6,823,966; and Halevy U.S. Pat. No. 7,357,224. See also, Ador Published U.S. App. No. 20020112916; Price Published U.S. App. No. 20020158098; Gelman Published U.S. App. No. 20030159887; Richardson Published U.S. App. No. 20040140152; Fischer et al. Published U.S. App. No. 20060011415; Harris Jr. Published U.S. App. Nos. 20060113147 and 20100122874; Moon et al Published U.S. App. No. 20070158139; and Botti Published U.S. App. No. 200702460298.

Jordan U.S. Pat. No. 6,487,725 was cited against an earlier related application. But it clearly addresses a waist wrap around harness—for beneath just the wearer's coat. It has no protection and/or linkage to the wearer's upper thighs or legs as does the Lower Unit of the present invention.

Grillot et al. U.S. Pat. No. 7,971,273 addresses multiple drag point devices, something which is preferably added to the upper rear of this invention with the understanding that the outer coat would include means for accessing the drag pull in an emergency while the fireman continues to wear his outer protective coating. In this manner, an unconscious firefighter could first be pulled to an exiting point, then latched on with the present harness before being lowered to safety (all while still unconscious).

### BRIEF SUMMARY OF THE INVENTION

It is the principal object of the present invention to provide an improved controlled descent system that can provide full body protection to all firefighter outerwear. A related object is to provide a full body EDS full body harness (i.e., both chest and legs) that can enable firemen and firewomen a fail-safe descent from the elevated levels of most any burning structure.

Firefighting personnel with an integral descent controller built into their protective gear at very little extra weight “cost”, can work better, more effectively knowing that should certain circumstances arise, they should more easily achieve a safe evacuation from the higher floors of a burning complex.

In accordance with the foregoing objects, the present invention incorporates into most any existing (or newly constructed) fire coat and pant combinations a full body harness consisting of a panel housing flame resistant rope or cable, a purposefully designed control descent rack in and through which that rope/cable is wound. That same rope/cable is also wound about a friction brake with a braking handle as described in more detail below.

### BRIEF DESCRIPTION OF THE SEVERAL VIEWS OF THE DRAWING(S)

Further features, objects and advantages of this invention will become clearer when reviewing the detailed description made with reference to the accompanying photographs in which:

FIG. 1 is a top plan view of a fully assembled harness unit outside of a new or used firefighter's coat/jacket and pants;

FIG. 2 is a front perspective view showing the invention from FIG. 1 fully installed on a mannequin but with the firefighter's coat/jacket and pants removed for better illustration purposes;

FIG. 3 is a top plan, close up view showing one preferred method for inserting the flame resistant rope through the control descent rack of this invention;

FIG. 4 is a top plan, close up view showing one preferred method for inserting flame resistant rope through the KEVLAR® brake of this invention;

FIG. 5 is a top plan, close up view showing one preferred method for inserting flame resistant rope through the brake, its KEVLAR webbing sleeve and into a visible section of their elastic storage loops;

FIG. 6 is a rear perspective view showing the invention from FIG. 1 fully installed on a mannequin with the firefighter's coat/jacket and pants removed;

FIG. 7 is a top plan, close up view showing a firefighter's coat/jacket before connecting to other integral components of that Upper Unit therein;

FIG. 8 is a top plan view showing the same coat/jacket from FIG. 7 with the Upper Unit installed, before the protective interior liner would be installed there over;

FIG. 9 is a top perspective view showing the coat/jacket from FIG. 8, with the Upper Unit installed and the protective interior liner starting to be installed there over;

FIG. 10 is a top plan view showing the coat/jacket from FIG. 9 with the protective interior liner fully installed over the Upper Unit portion of this invention;

FIG. 11 is a top perspective view showing the leg openings for the fireman's pants according to one embodiment of this invention, sitting atop the opened, lined jacket from FIG. 10;

FIG. 12 is a top perspective view showing a lateral side pocket to the fireman's pants with a cover flap removed;

FIG. 13 is a top perspective view showing the protective liner fully in place in the pants, covering up the leg loops. Note how the TG Pants Leg Loops of this invention do not penetrate the Liner;

FIG. 14 is a top perspective view showing the FireCoat FEDS Leg Straps and Male Safety Buckles have been removed from the TG Coat storage locations and attached to the TG Pants Leg Loops Female Safety Buckles in each Pants Side Pockets;

FIG. 15 is a top perspective view showing the TG Pocket Flaps attached to its corresponding Velcro on the Pants pockets;

FIG. 16 is a top perspective view showing the TG Coat and Pants completely closed over the FireCoat FEDS;

FIG. 17 is a front perspective view with the FireCoat FEDS Chest Straps removed from their Storage Pockets and attached to their corresponding Safety Buckles;

FIG. 18 is a top perspective view showing the Emergency Drag Strap Storage Location;

FIG. 19 is a top perspective view showing the Emergency Drag Strap removed from its Storage Location;

FIG. 20 is a top plan view showing one embodiment of external (or outer) coat shell with its protective insulating inner liner lifted out of the way to better see the rope panel attached to its inner rear wall;

FIG. 21 is a top plan view showing one of two outer shell coat pockets that, when lifted up, expose for extraction through that coat pocket one of the pair of chest straps that'll be joined to one another OUTSIDE the coat wearer's outer shell;

FIG. 22 is a top perspective view showing a lower inner edge to one embodiment of coat panel with its exposed pants leg loop buckle dangling down therefrom; and

FIG. 23 is a top perspective view “looking down” into one of two firefighter pants pockets with its cover flap raised for visibility purposes.

### DETAILED DESCRIPTION OF PREFERRED EMBODIMENTS OF THE INVENTION

With reference to the accompanying drawings, there is shown a first preferred embodiment of FEDS, or full body emergency descent system incorporated into the protective outerwear (gear) of a firefighter according to the present invention.

The accompanying drawings show one preferred embodiment of FireCoat FEDS complete and installed (at various stages) on a mannequin for wearing illustration purposes. It is important to note several unique aspects of this design. This is a Full Body Safety Harness fully integrated into a firefighter's coat/jacket and pants. This is not a safety waist belt only or a safety chest strap only (unlike some of those shown in the prior art). Rather, this is a Full Body Rappelling System with integrated 115 feet of stored line into a firefighter's clothing that allows for very quick donning and utilization that is a must for firefighters to react quickly to life threatening events. Current Bailout Bags contain only 50 feet of line. And they are bulky accessory on the outside of the firefighter's clothing that can catch on objects in an emergency situation. Worse, the individual firefighters must put such a bag ON before leaving the station or truck. The FEDS invention herein, by contrast, is always with them; it never has to be donned or separately put on over existing protective wear clothing or equipment.

Firefighters are required to enter burning buildings where the temperatures can be several hundred degrees. To protect the Firefighters from being injured or killed they wear protective clothing, called Turnout Gear (TG). This TG consists of several items including a fire protective coat and pants. The Coat and Pants both have two layers; the inside Heat Protective Barrier Liner that is against the Fireman's skin or underclothing, and the outer Coat or Pants of heat resistant material usually Nomex. The inside Heat Protective Barrier Liner is of vital importance since the Coat and Pants may be exposed to very high heat. The Liner cannot be penetrated at any point to keep the Fireman's skin cool. If the Liner becomes penetrated, very high heat can penetrate through the opening to the Fireman's skin and burn them.

It is very common that at times, Firemen must retreat from a burning structure due to the increasing heat or deterioration of the structure which can collapse on top of the Firemen, severely injuring or killing them. To affect this escape, they will retreat out doorways, or windows if available. If the Fireman is on elevated floors of the structure, the ability to escape a deteriorating situation is limited. If a ladder is not available or is not of sufficient length to reach a window where a Fireman has retreated to affect his escape, Firemen have jumped, severely injuring themselves and some have died.

In January 2005, six Bronx N.Y. Firemen were forced to jump from a window fifty feet above ground to escape a burning and deteriorating building. Two of the Firemen died and the other four were grievously injured. An Integrated Escape System built within their Turnout Gear was not then nor is now available to Firemen. A Bailout Bag is available for Firemen that contains a rope and descending device that is worn on the OUTSIDE of the TG, similar in function to Jordan (U.S. Pat. No. 6,487,725). These are not commonly worn by Firemen due to the fact that they are on the OUTSIDE of the TG and for other reasons that will be pointed out. The Bailout Bag and a Jordan style escape system worn on the outside of the TG are a source of obstructing the Fireman's movement and can be snagged on a broken board or other item and stop the Fireman from escaping a dangerous situation. Firemen are very leary of anything attached to the outside of their clothing due to the danger it can create.

Also, both Bailout Bag and the Jordan design must be placed over the TG once the Fireman has gotten dressed in an emergency. Firemen do not have time to place additional equipment on when responding to emergency calls, this is another reason why a Bailout Bag or a Jordan style escape system is not commonly utilized, they take too much time to put on. Firemen must respond in seconds when the alarm is sounded to save lives and property. They will not take the additional time to place on additional equipment that may be hazardous to their movement while fighting a fire in a burning building.

The FireCoat FEDS (Fullbody Emergency Descent System) eliminates these problems. The FireCoat FEDS is a Personal Rappelling System that is built into a Fireman's Coat and Pants. It contains 115 feet of Heat-Resistant Rope, ¼″ diameter and extremely strong at 8200 pound breaking strength. This line is TECHNORA® which is very light, strong, soft and very Heat-Resistant. The 115 feet of rope weighs only at 2 pounds. If needed in an emergency, the FireCoat FEDS can be utilized in less than 1 minute. The endangered Fireman can attach the Rope to a solid anchor point, and safely lower him or herself, down the rope and out of danger. The slow descent down the Rope is controlled, in part, by the Controlled Descent Rack, and KEVLAR Brake as the Rope is being pulled from its storage location in the back of the Coat. It is very simple to connect and operate.

The FireCoat FEDS is integrated into the Turnout Gear. It is attached to the inside of the Coat and Pants. It is overtop of the Heat Protective Barrier Liner. It does not penetrate the Heat Protective Barrier Liner in anyway. When the Firemen respond in an emergency, they have nothing extra to put on. The FIRECOAT FEDS is already attached to the Turnout Gear between the Heat Protective Barrier Liner and the outer Coat and Pants. When the Firemen must respond in seconds, they do not have time to put on additional equipment. The FIRECOAT FEDS emergency escape system is always with them, they will not need to jump from a window to escape a burning building.

The FIRECOAT FEDS emergency escape system of this invention may be added, by retrofitting, into existing sets of firefighter's coats and pants. Alternately, they may be adapted for including with all newly constructed firefighter coat and pants sets going forward.

There are two main parts to the FIRECOAT FEDS, the upper and lower units. The Lower Unit consist of two loops of fire-resistant KEVLAR webbing that is integrated and sewn into both legs of the TG Pants, underneath the outer Pants and overtop of the Heat Protective Barrier Liner. Both loops form Leg Loops that completely encircle the Fireman's upper legs and terminate with an attached female buckle in the Pants Pockets on both lateral sides of the Pants. The Buckle attached to the Leg Loop is sewn into the inside of the Pocket on both sides of the Pants. The female Buckle is not visible and is not on the outside of the TG Pants but is easily accessed by pulling up on the Velcro-ed Pants Pocket Flap, exposing the Buckle securely attached to the inside of the pocket, which is attached to the leg loop encircling the Fireman's legs.

The Upper Unit consist of a fire-resistant KEVLAR webbing Safety Harness that contains 115 feet of light weight ¼″ diameter Heat-Resistant Rope with an 8200-pound breaking strength. This rope is securely stored in vertical positions on the inside of the TG Coat, in a Storage Panel consisting of a series of fire-resistant elastic storage loops. The Storage Panel is zippered to the inside of the back of the Coat. The Upper Unit of the FIRECOAT FEDS does not penetrate the Heat Protective Barrier Liner. The Upper Unit is over top of the Heat Protective Barrier Liner and underneath the Coat.

Attached to the Upper Unit Safety Harness are two Chest Straps, one on the right side of the Safety Harness and one on the left side of the Safety Harness. The ends of these two Chest Straps are stored in the Coat Upper Outside Pockets. Both Chest Straps enter the Coat Pockets by small slit openings on the inside of both Coat Upper Side Pockets. The right and left Chest Straps are stored in the Coat Upper Side Pockets and are not visible on the outside of the TG Coat unless pulled out of the pockets when an emergency escape is needed.

The Chest Straps do not penetrate the Heat Protective Barrier Liner. The entire Upper Unit Safety Harness is between the Coat and the Heat Protective Barrier Liner. In an emergency, the Fireman can remove both Chest Straps from the Coat Upper Pockets on each side of the Coat, place them in front of the Fireman's chest and connect both straps to each other by the attached Male and Female Safety Buckles. This action causes a complete encircling of the Fireman's Upper Chest by the KEVLAR Fire-Resistant Webbing, placing the Rope, Controlled Descent Rack, and Brake in front of the Fireman for easy and quick use.

The Left Chest Strap contains a Male Safety Buckle that can be tightened when attached to the Female Safety Buckle by pulling on the end of the Left Chest Strap. The Right Chest Strap contains the Female Safety Buckle, Controlled Descent Rack with the pre-wrapped rope, and Brake. The Controlled Descent Rack is a friction device that allows for a person's descent down a rope. The Controlled Descent Rack has Three Cross Members that the rope is wrapped around to increase friction slowing the rate of descent of the Fireman. The Controlled Descent Rack is pre-wrapped with the end of the stored rope that contains a braided loop end for attachment to a solid anchor if an emergency descent is needed.

The 115 feet of stored rope located in the back of the Safety Harness, follows the Right Chest Strap up out of the Coat Right Chest Pocket, goes through the Brake attached to the Right Chest Strap, transitions up through the Controlled Descent Rack's cross members and then is attached to a solid anchor when in use. This allows the Fireman to safely descend from a dangerous situation, while the Rope is being pulled from the Storage Loops in the back of the Safety Harness by the Fireman's weight, passing through the Brake and transitioning up through the Controlled Descent Rack and to the solid anchor point.

The Brake is composed of 1″ KEVLAR straps that is formed to create pressure on the rope as it is pulled towards the Controlled Descent Rack. It is important to note, that due to the design of the KEVLAR Brake, very small diameter ropes can be used, down to ⅛″ diameter. The TECHNORA ⅛″ rope is 2,800 pound Tensile Strength, the 3/16″ diameter rope is 5,600 pound Tensile Strength, and the ¼″ is 8,200 pound Tensile Strength. Due to the unique design of the KEVLAR Brake, these very small diameter ropes can be used. This allows for considerable lengths of rescue rope to be incorporated into the FireCoat FEDS without using much space which is very limited, and considerable less weight than a normal rescue rope which is ⅜″ to ½″ diameter.

The KEVLAR Brake design makes this possible. Per NFPA Standards, a hand-held rope less than ⅜″ diameter is not permitted. This is due to the fact that the human hand or other rescue rope brakes are unable to generate enough force on a rope smaller than ⅜″ to ensure enough braking force to slow a descent. This is not a problem with the FireCoat KEVLAR Brake. The KEVLAR Brake wraps around the rope and causes increased friction over 360 degrees and a two-inch length of the rope as it slides through the KEVLAR Brake. The KEVLAR Brake pressure is applied by the Fireman pulling down on a handle of loop webbing extending down from the KEVLAR Brake. Even if the KEVLAR Brake is not applied by the Fireman, the rate of descent will be of such a slowed nature due to the Controlled Descent Rack, less than 10 feet per second, that the Fireman will survive even a non-braked 100-foot emergency descent.

Furthermore, with respect to the Brake and Brake Handle of this invention, it must be noted that in the most severe of situations where a life or death decision must be made for an unconscious/incapacitated or injured Fireman, a fellow Fireman can remove the unconscious Fireman's FireCoat FEDS Chest Straps from their storage locations in the unconscious Fireman's Coat, connect the safety buckles together, pull the heat and cut resistant rope up through the Controlled Descent Rack attached to the Chest Straps and attach the rope to a secure anchor point. The rescuing Fireman can then push the unconscious Fireman out a window or off an elevated position of danger to a safer one. Even while the unconscious or injured Fireman is not able to apply the KEVLAR Brake, the rate of descent is still less than 10 feet per second and the unconscious Fireman will survive a descent distance that would normally kill or maim. This is allowed by the friction created while the rope transitions up through the Controlled Descent Rack. Such a configuration allows even an unconscious/incapacitated Firemen to be saved with this invention. The Brake is used to slow or stop a descent. It is not needed to allow for a safe gradual descent per se.

The Upper Unit Safety Harness also contains two Leg Straps with Male Safety Buckles that extend from the upper sides of the Upper Unit Safety Harness and are stored in the bottom of both sides of the inside of the Coat by securely attached Female Safety Buckles located there. Again, the Leg Straps do not penetrate the Heat Protective Barrier Liner and cannot be seen while not in use. If an emergency descent is needed, the Leg Straps can be removed from their storage positions by the Fireman, by reaching under the front bottom of his coat only a couple of inches, removing the Leg Strap Male Safety Buckle from its Female Safety Buckle storage location, and attaching it to the Female Safety Buckles located inside of the Fireman's Side Pants Pockets that are attached to the Leg Loops. By making this connection of the Leg Straps from the Upper Unit Safety Harness to the Lower Unit Leg Loops, this creates a FULLBODY Safety Harness that encircles the Fireman's Chest and Legs after the Chest Straps are connected.

In an emergency escape situation, the Fireman can connect the Leg Straps to the Leg Loops, attach the Chest Straps together, connect the end of the Fire-Resistant Rope to a solid anchor, go out a window and be able to safely descend to the ground. With using the attached Brake, the Fireman has the ability to greatly slow the descent or stop at any point. This emergency escape can be done in less than a minute. If there is no time to attach the Leg Straps to the Leg Loops, the Fireman has the option of quickly attaching the Chest Straps only, attach the line to a solid anchor point and go out a window in even faster time. In a dire emergency situation 10 seconds can be a long time.

Also attached to the Upper Unit Safety Harness is an Emergency Drag Strap. It is common for Firefighters to become unconscious due to heat and or smoke inhalation. When this happens, other Firefighters will need to drag the unconscious member to safety. It is very difficult to pick up an unconscious Fireman or woman with all his/her clothing and equipment. A properly placed Emergency Drag Strap makes the moving of a downed Fireman quicker and safer even for a single Fireman responding to the downed person. The FIRECOAT FEDS Emergency Drag Strap is attached to the rear of the upper section of the Upper Unit Safety Harness under the Outer Shell Coat. It is designed to be pulled from underneath a covered slot located in the upper back area below the collar of the Coat of the TG. Once pulled, this Emergency Drag Strap which completely encircles both upper arms, tightens around both arms and shoulders and cannot come lose while pulling the victim to safety. If the Emergency Drag Strap was only attached to the Coat, there is a possibility that when pulling a heavy man, the Coat's upper front zipper could be forced up against the throat of the unconscious Fireman causing strangulation that could be unseen by the rescuing Fireman in the dark or smoke-filled building. By encircling both arms, the FIRECOAT FEDS Emergency Drag Strap eliminates that possibility; the unconscious Fireman's body is being pulled, not his clothing.

The Bailout Bag is used in conjunction with a Seat Harness that must be put on when the Fireman puts on his TG Pants. The Jordan device is a waist belt style device. OSHA has determined that waist belt descending safety devices are dangerous and not permitted to be used. A person using a waist belt only can lose consciousness quickly by the enormous pressure placed on the abdominal cavity causing the wearer not to be able to breath affectively. The US Airforce in 1987 determined that a person suspended by a single waist belt can become unconscious in 30 seconds due to the intra-abdominal pressures exerted on a human body. With only a waist belt attachment point on a rope, the body can also end up inverted due to the upper weight of a man's body is heavier than his legs and can cause the body to tip upside down.

The FIRECOAT FEDS is a FULLBODY Safety Harness design. Both Legs must be supported by the Safety Harness design before it can be certified under current ANSI Z359 Standards. The FIRECOAT FEDS is designed to comply with Fullbody Safety Harness NFPA and ANSI Z359 Standards. The Jordan disclosure, U.S. Pat. No. 6,487,725, cannot be certified to NFPA or ANSI Z359 Standards and is NOT permitted for use by OSHA as a single waist belt design.

The FIRECOAT FEDS is the only Emergency Escape design that is completely integrated into Firemen's Turnout Gear, does not need to be additionally placed over the TG after the Firemen is dressed, does not increase the time it takes for a Fireman to dress and respond in an emergency situation, the Fireman's Emergency Escape device is always with them, they cannot leave it at the Fire House, will not snag on any object since it is completely underneath the Fireman's Outer Shell Coat and Pants, does not penetrate the Heat Protective Barrier Liner anywhere, can be certified to NFPA and ANSI Standards as a FULLBODY SAFETY HARNESS and is allowed by OSHA.

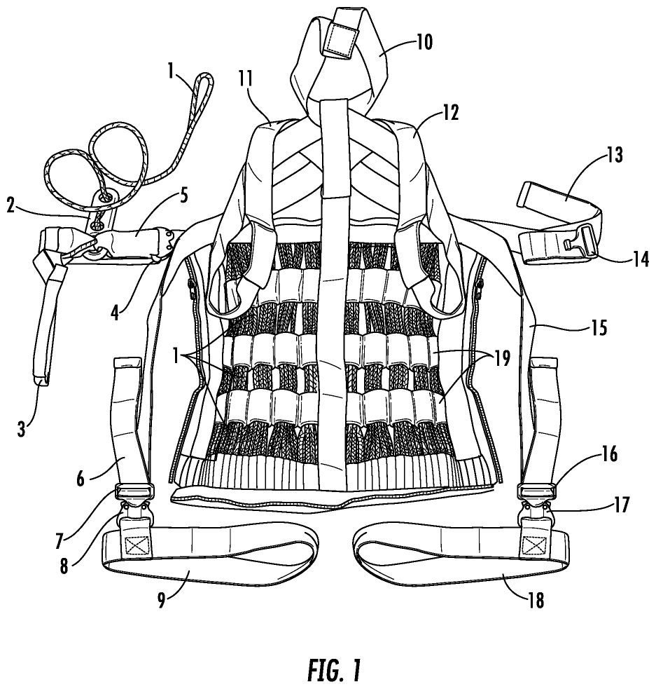

FIG. 1 shows a completed FireCoat FEDS before being attached into a Fireman's Turnout Gear (TG) Coat and Pants. This entire unit will be OVERTOP of the Heat Protective Barrier Liner and UNDERNEATH the Outer Shell TG Coat and Pants (not shown in this view). The Completed FireCoat FEDS from Top to Bottom, shows the Emergency Drag Strap 10 that continues to form two loops, right shoulder loop 11 and left shoulder loop 12, that the arms goes through when the TG Coat is placed on by the Fireman. The 115 feet of stored Heat-Resistant ¼″ High Strength Rope 1 is shown in its vertical Heat-Resistant Elastic Storage Loops on panel 19. The Rope 1 travels from these Storage Loops along the Right Chest Strap 5, through a section of KEVLAR Sleeve, KEVLAR Brake 3, and is wound up through the Controlled Descent Rack 2. The Rope 1 has a Braided Loop on its end for attaching to a Solid Anchor Point prior to being used for descent. The Right Chest Strap 5 has an attached Female Safety Buckle 4 that corresponds to the Left Chest Strap 13 and its attached Male Safety Buckle 14. These two buckles are attached together prior to using the FireCoat FEDS for Emergency Descent. Two Leg Straps 6, 15 are shown attached to two Leg Loops 9, 18 by their respective Safety Buckles sets 7, 8 and 16, 17. These two Leg Loops 9, 18 with their Female Safety Buckles 8, 17 will be sewn into the TG Pants. The Leg Loops Safety Buckles terminate into the TG Pants Lateral Side Pockets (not shown in this view). The two Leg Straps 6, 15 with its Male Safety Buckles are stored in the TG Coat until needed to be attached to the Female Safety Buckles on each Leg Loop 9, 18. Once these Leg Straps 6, 15 are attached to the Leg Loops 9, 18 and the Chest Straps 5, 13 are connected, the FireCoat FEDS becomes a FULLBODY SAFETY HARNESS and can be used in Emergency Descents to escape a burning or deteriorating structure.

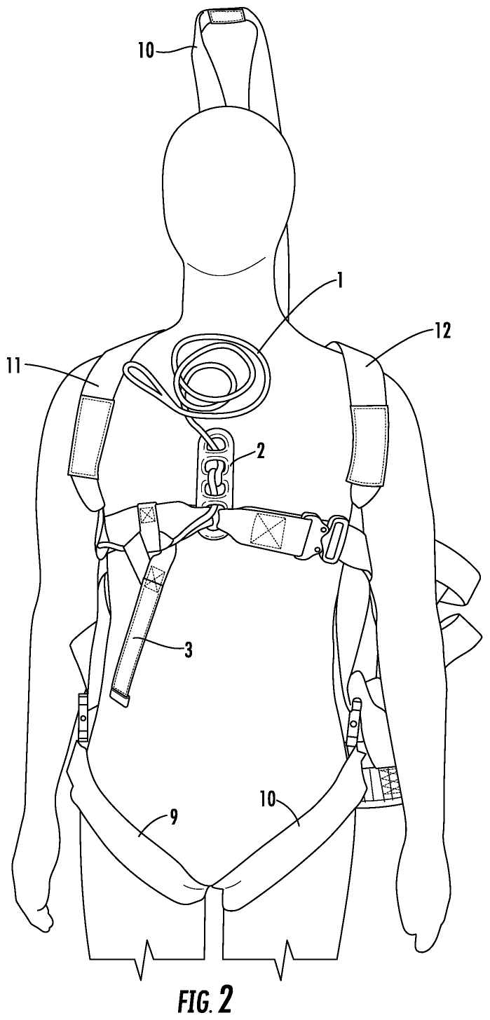

FIG. 2 illustrates the FireCoat FEDS front view as it would appear over the TG Heat Protective Barrier Liner and beneath the TG Coat and Pants (neither of which can be seen in this view). The Emergency Drag Strap 10 is shown above the mannequin's head with its Arm Loops 11, 12 over the shoulder areas. The Chest Straps are shown attached which would be OVERTOP of the TG Coat after being removed from their storage locations in the TG Coat Upper Pockets and attached together in front of the Fireman. The rope 1 is shown after coming from the Rope Storage Loops going through the Right Chest Strap Brake 3 and up through the Controlled Descent Rack 2. The Brake Handle Reflective Strip is shown over the folded Brake Handle Loop. During FireCoat FEDS use, the Fireman will place his hand into the Brake Handle Loop to pull down on the Brake 3, for slowing or completely stopping descent.

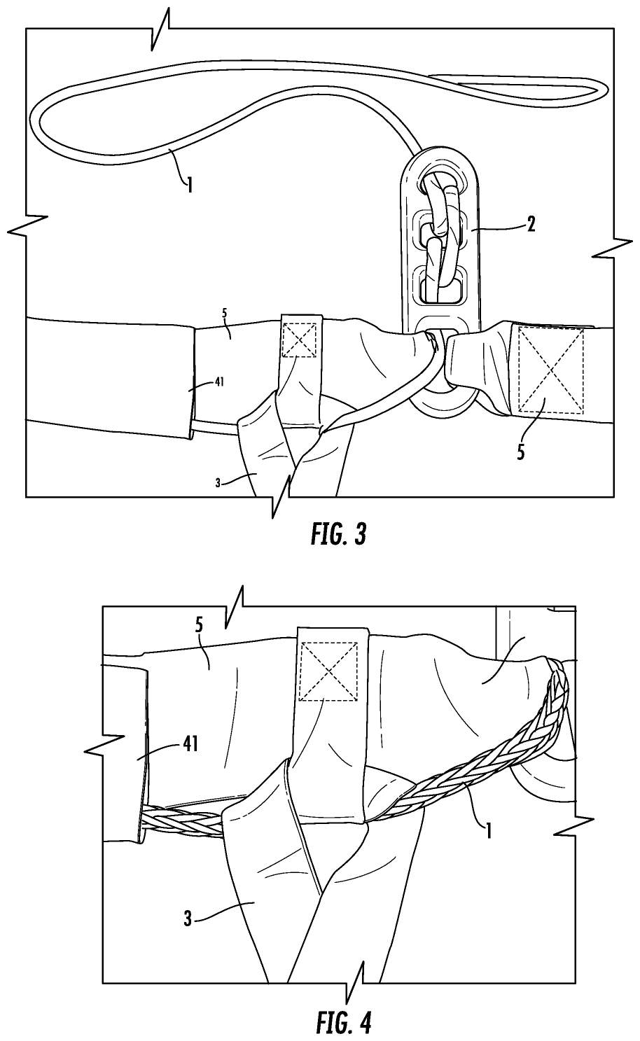

FIG. 3 shows the FireCoat FEDS Right Chest Strap 5 except the Female Safety Buckle located on the end cannot be seen in this view. The Controlled Descent Rack 2 is shown with the Rope 1 already wrapped around its Cross Members to slow a Fireman's Emergency Descent. This Patented Friction Device, Wood (U.S. Design Pat. No. 684,845) allows for a quick and safe Emergency Descent from a life-threatening situation. It is composed of very high strength 6061 T6 Forged Aluminum. This Controlled Descent Rack has been Certified by Underwriters Laboratory to ANSI Standard Z359.4, for Multiple Descents of 1000 Feet. UL Registration Number MH-49356.

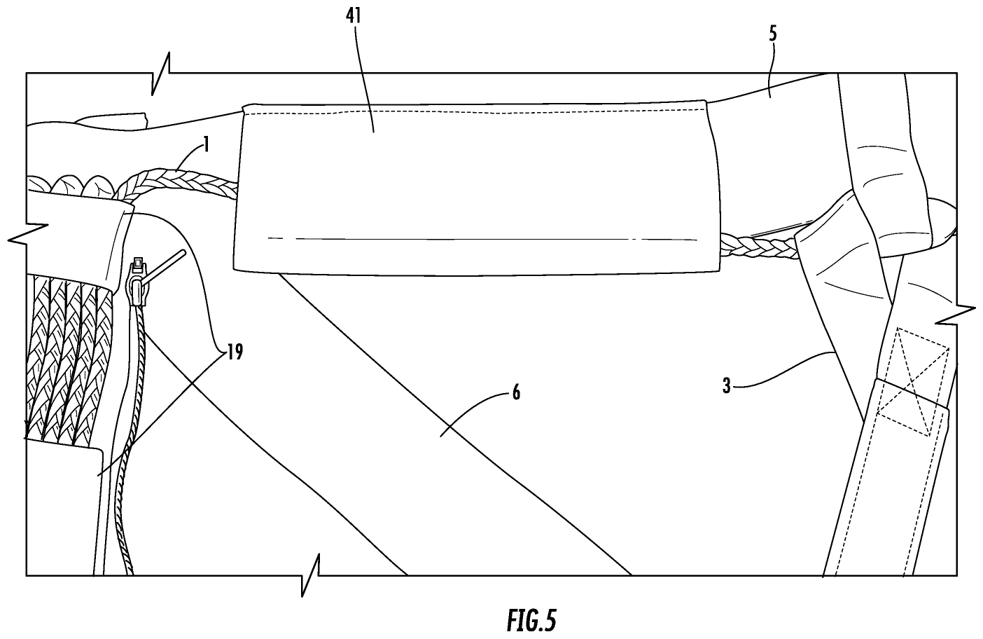

FIG. 4 shows the Rope 1 along Right Chest Strap 5 as it exits the KEVLAR Sleeve 41 and travels through the KEVLAR Brake 3 to the Controlled Descent Rack 2. The KEVLAR Brake 3 is a very effective design to slow or completely stop a descent. By pulling on the KEVLAR Brake Handle Loop, (Not Shown), the Rope 1 is pressured over a 360-degree circumference and two-inch area in length. When pulling on the Brake 3, the Rope 1 is also bent in a downward angle, increasing the friction and braking ability to slow or stop an Emergency Descent.

FIG. 5 shows the Heat-Resistant ¼″ High Strength Rope 1 beginning in it's Heat-Resistant Elastic Storage Loops (left side in this view), traveling along the Right Chest Strap 5, through the KEVLAR Webbing Sleeve 41, and through the KEVLAR Brake 3. All material that supports or significantly pressures the Rope 1 is KEVLAR. This is because other material can melt and stop the Rope 1, which is TECHNORA® material, as it quickly slides from the Elastic Storage Loops along the Right Chest Strap 5 and up through the Controlled Descent Rack (not seen in this view). The KEVLAR Webbing Sleeve 41 serves a dual purpose, i.e., it keeps the line along side of the Right Chest Strap 5 and it prevents the line from being snagged by some object during descent. The KEVLAR Brake 3 is able to exert sufficient pressure on the Rope 1 to slow or stop a descent without excessive wear.

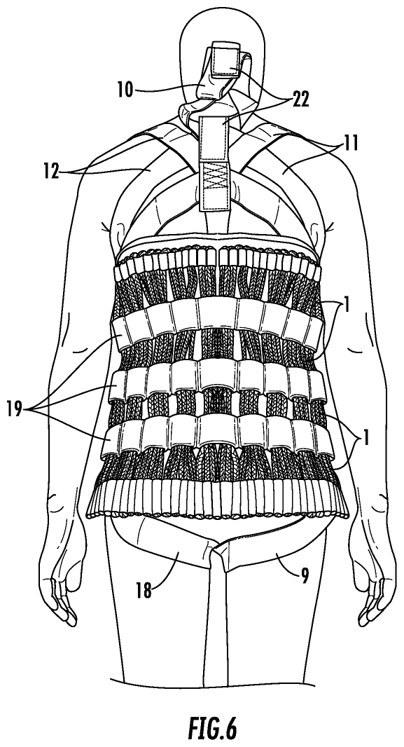

FIG. 6 illustrates the FireCoat FEDS rear view as it would appear over top of the TG Heat Protective Barrier Liner and underneath the TG Coat and Pants. The Emergency Drag Strap 10 is shown on the mannequin's head with its Arm Loops 11, 12 over the shoulder areas. The Stored Rope in its Elastic Storage Loops is shown as well as the TG Pants Leg Loops 9, 18.

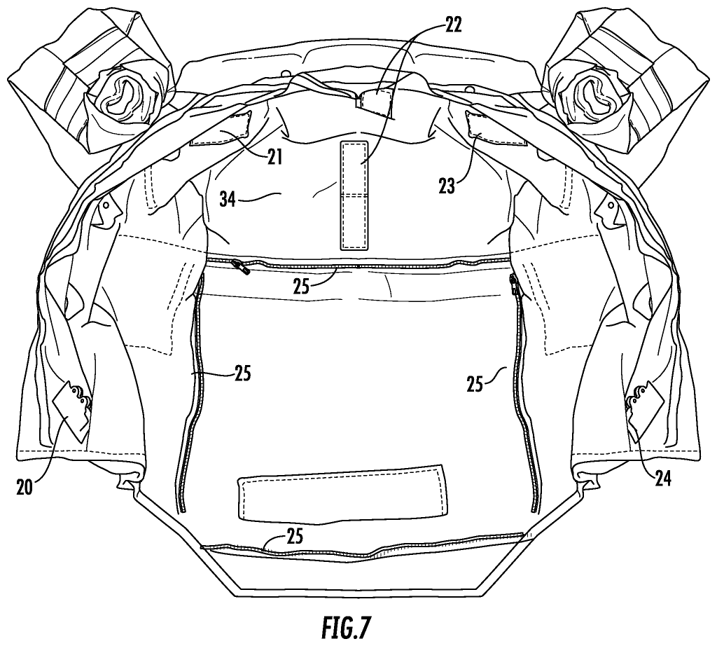

FIG. 7 shows the inside of the TG Coat with the Heat Protective Barrier Liner removed. The FireCoat FEDS attachment zippers 25 and Velcro 22 are shown already attached in their places inside the TG Coat.

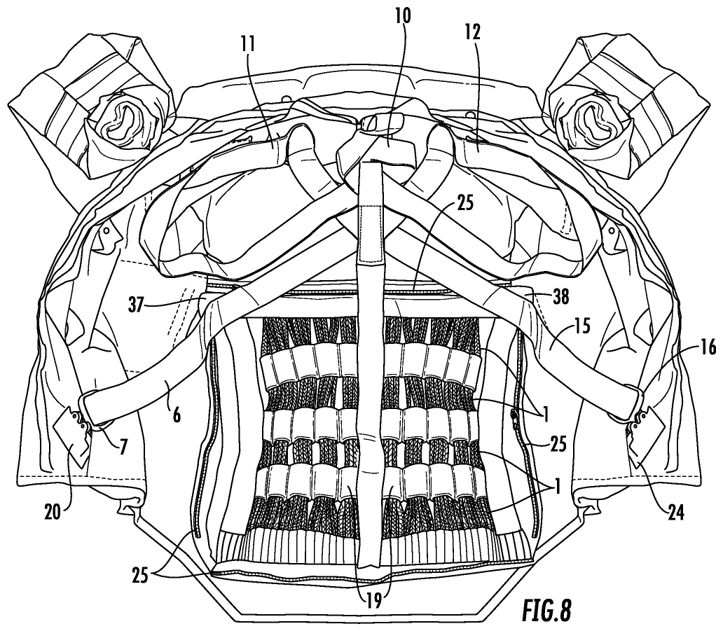

FIG. 8 shows the FireCoat FEDS attached inside of the TG Coat, once more with the Heat Protective Barrier Liner removed. Top to Bottom, the Emergency Drag Strap 10 is attached to its Velcro attachment point just below the TG Coat's collar midline. The Emergency Drag Strap Arm Loops 11, 12 can be seen attached to their corresponding Velcro attachment point. The Chest Straps are not visible because they are placed through slots on both insides of the TG Coat that enter into the TG Coat exterior pockets where the Chest Straps 5, 13 are stored on each side. The Heat-Resistant Rope 1 is shown in its stored position in its Heat-Resistant Elastic Storage Loops and attached to the TG Coat by corresponding zippers 25 on all sides of the Storage Loop Panel 19. The Leg Straps 6, 15 attached Male Safety Buckles 7, 16 are shown stored in their corresponding Female Safety Buckles 8, 17 that are sewn to the TG Coat on both sides bottom adjacent to the TG Coat opening and closing zipper.

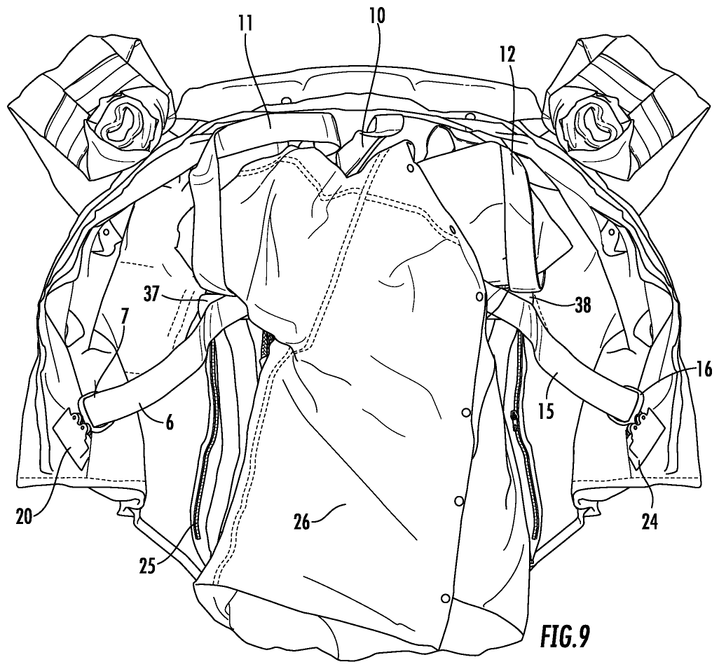

FIG. 9 shows the TG Coat Heat Protective Barrier Liner 26 partially in place with the arms of the liner extended into the arms of the Coat. Also shown are the Emergency Drag Strap Arm Loops 11, 12 over the Liner arms.

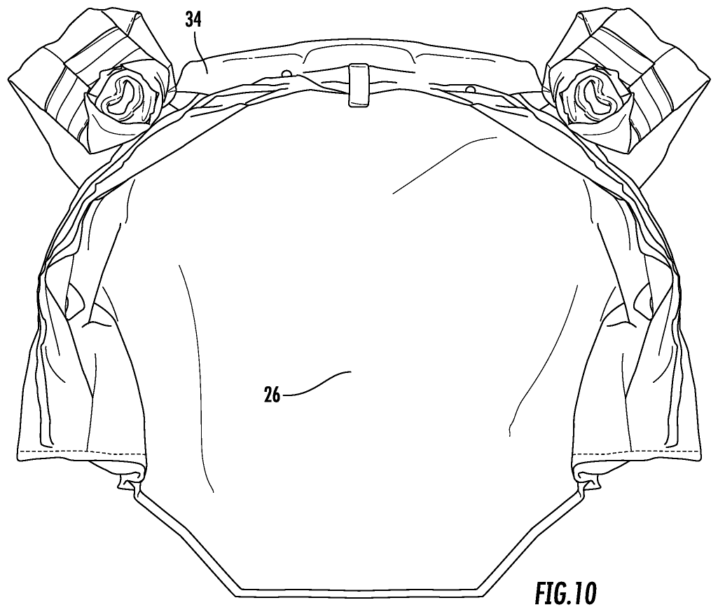

FIG. 10 shows the TG Heat Protective Barrier Liner 26 fully attached to the TG Coat 34. The FireCoat FEDS is completely concealed between the Liner 26 and Coat 34. The FireCoat FEDS does not penetrate the Heat Protective Barrier Liner 26 at any point.

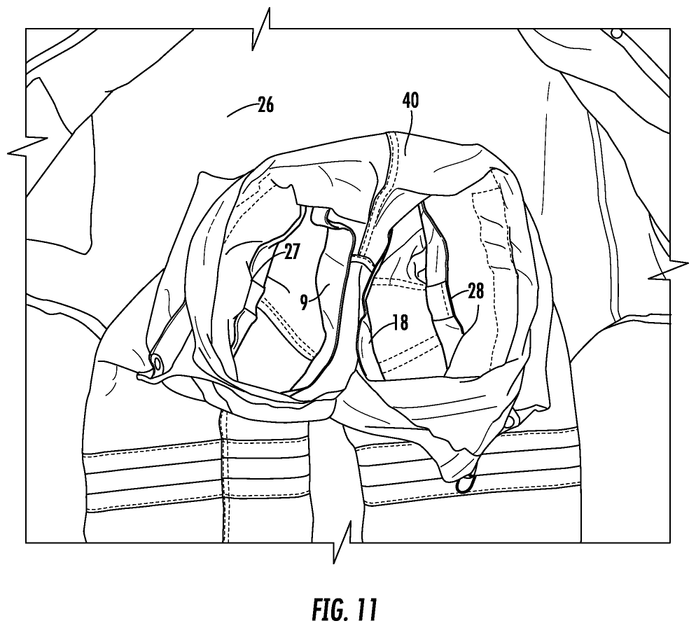

FIG. 11 shows the TG Pants 40 with the Heat Protective Barrier Liner removed. The view is down into both legs from the top. Shown is the TG Pants Leg Loops 9, 18 sewn into place with the attached Female Safety Buckles 27, 28 already positioned through slots on both lateral leg sides that enters into the TG Pants 40 lateral side pockets.

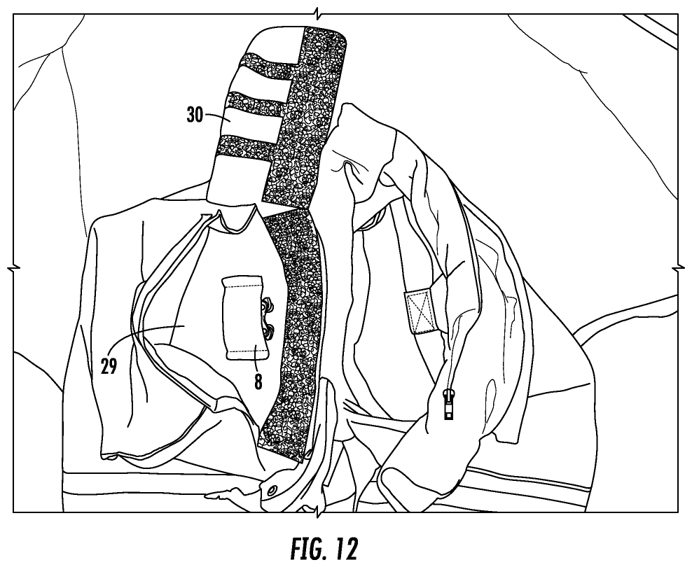

FIG. 12 shows the TG Pants Right Lateral Side Pocket 29 with its Flap 30 removed. Inside the pocket is seen the TG Pants Right Leg Loop Female Safety Buckle 8 sewn securely inside of the pocket after it had entered the pocket via the slit in the leg. Note the Pocket Flap 30 that is permanently sewn on only one end and is held in place by corresponding Velcro that is attached to the Pants over the Pocket 29. This allows for quick and complete removal of the Flap 30 to be able to clearly visualize the Leg Loop Female Safety Buckle 8. This clear visualization allows for a quick connection of the FireCoat FEDS Leg Straps and an equally quick recover of the Pants Pocket 29 with the Pocket Flap 30 being placed back over its corresponding Velcro attachment point.

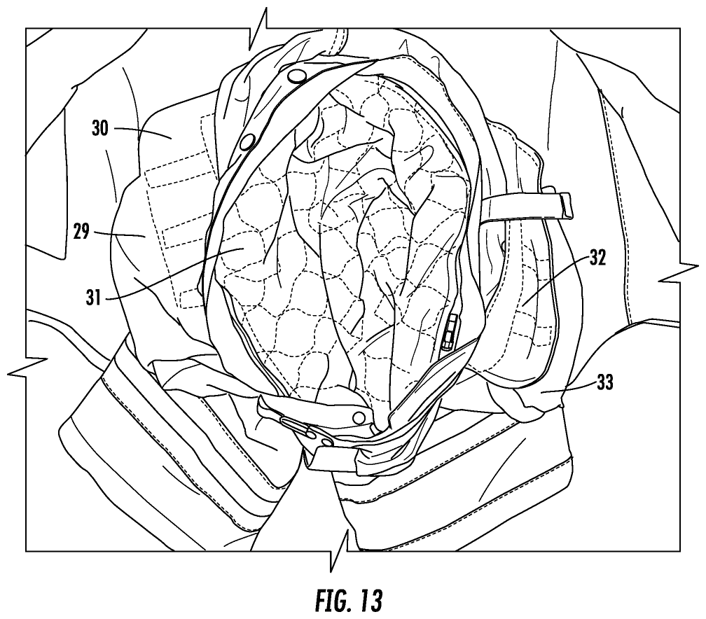

FIG. 13 shows the TG Pants Heat Protective Barrier Liner 31 fastened in place. The TG Pants Leg Loops do not penetrate the Liner 31.

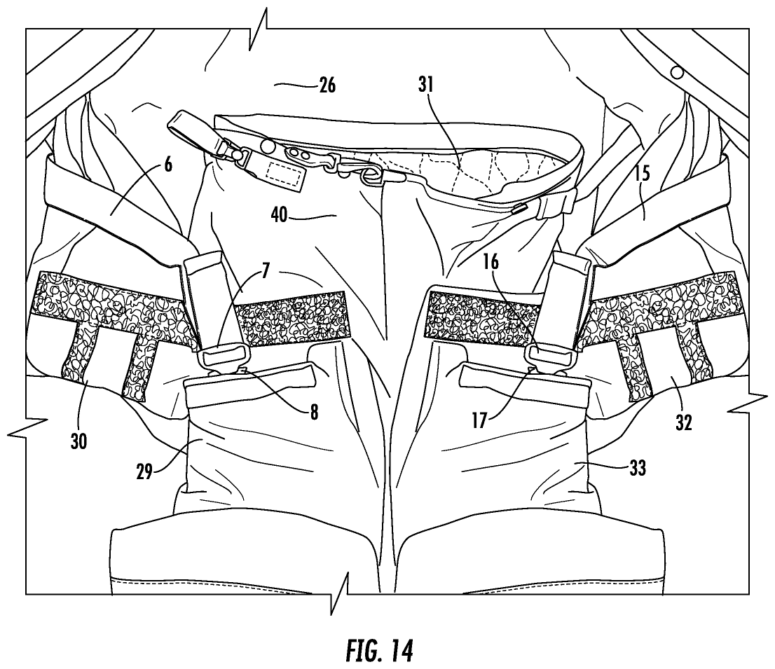

FIG. 14 shows the FireCoat FEDS Leg Straps 6, 15 and Male Safety Buckles 7, 16 have been removed from the TG Coat storage locations and attached to the TG Pants Leg Loops Female Safety Buckles 8, 17 in each Pants Side Pockets 29, 33. The Pants Pocket Flaps 30, 32 have been pulled back for visualization.

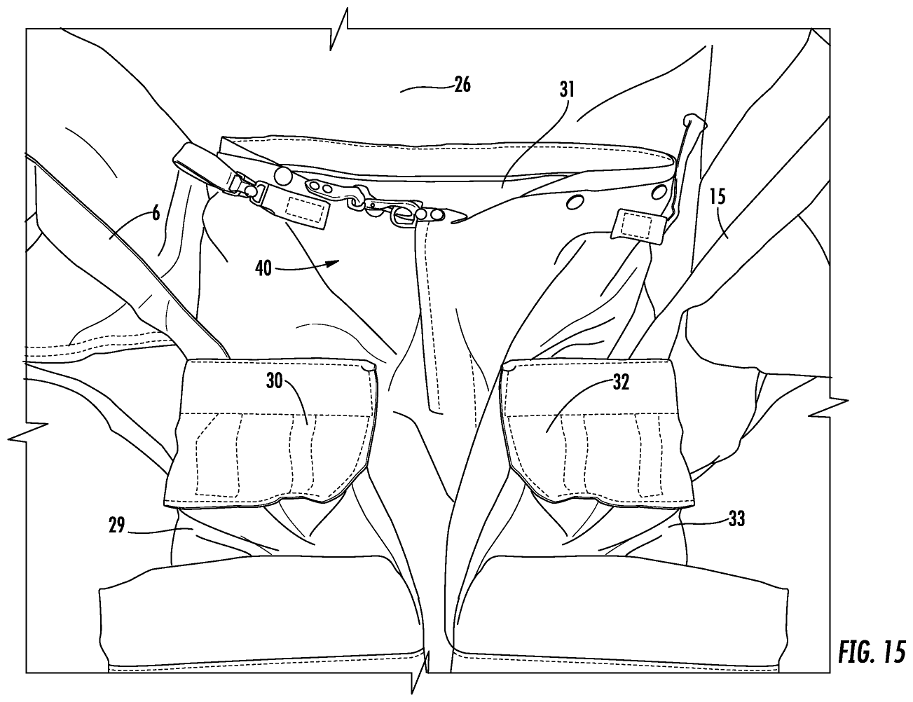

FIG. 15 shows both TG Pants Pocket Flaps 30, 32 have been replaced by attaching to its corresponding Velcro on the Pants 40 above and on each Pocket 29, 33.

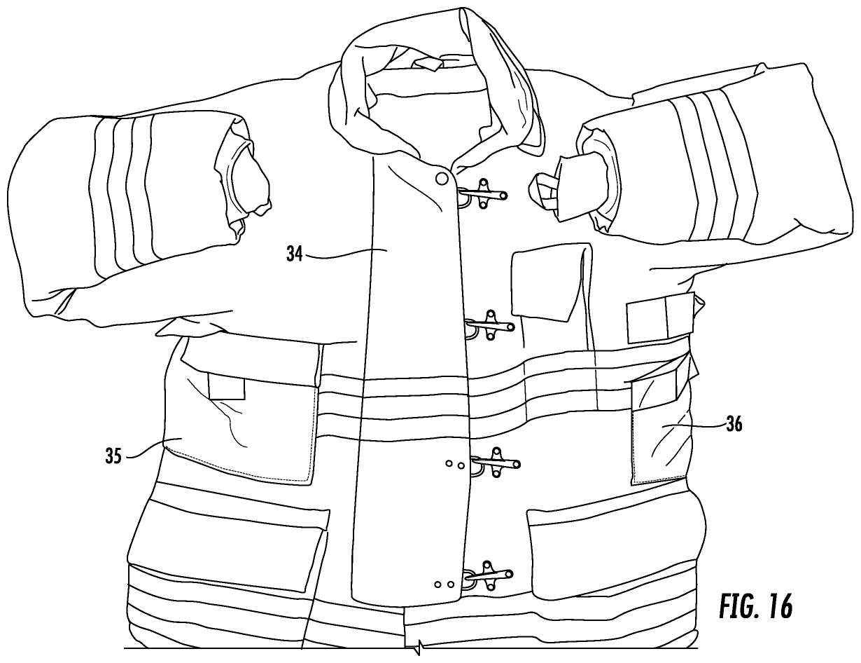

FIG. 16 shows the TG Coat 34 and Pants completely closed over the FireCoat FEDS. The FireCoat Feds is not seen and is not attached to the outside of the Fireman's Turnout Gear Coat 34 or Pants. The FireCoat FEDS Right and Left Chest Straps are stored in the Upper Pockets 35, 36 on each side of the Coat.

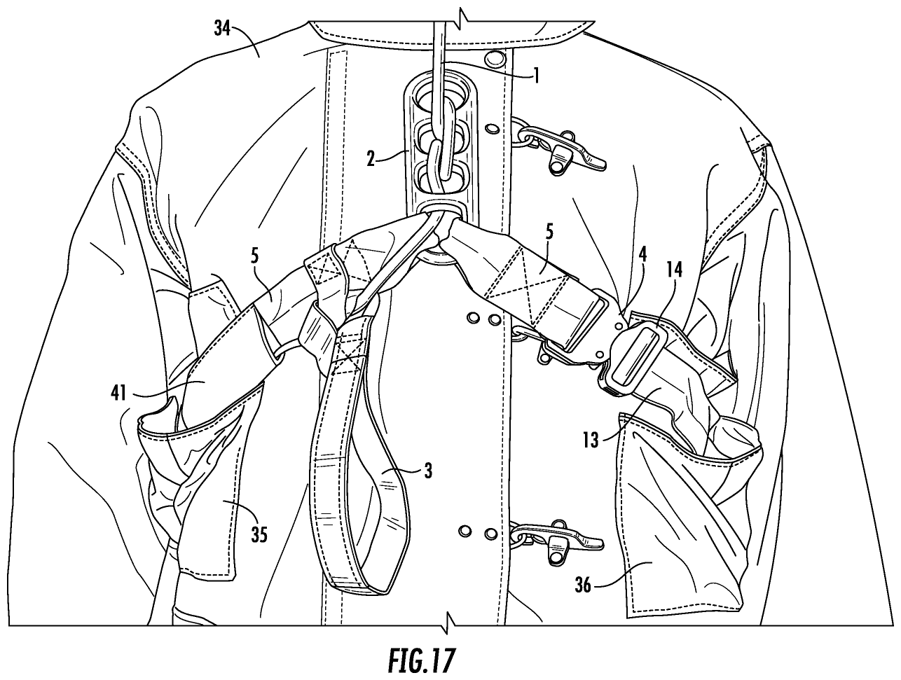

FIG. 17 shows the FireCoat FEDS Chest Straps 5, 13 have been removed from their Storage Pockets 35, 36 and attached to their corresponding Safety Buckles 4, 14. This places the Heat-Resistant Rope 1, Controlled Descent Rack 2 and KEVLAR Brake 3 on the Chest of the Fireman to execute an Emergency Escape from a Burning or Deteriorating Building. The time needed to pull the Chest Straps 5, 13 from their Storage Pockets 35, 36 and connect the Safety Buckles 4, 14 is less than one minute. Shown clearly is the KEVLAR Brake 3 Handle Loop with Reflective Tape on the front surface. The Reflective Tape is to be able to locate the KEVLAR Brake Handle Loop in poor visibility conditions. The Rope Loop (not shown) can be attached to a Solid Anchor Point and the Fireman can quickly and safely ESCAPE a life-threatening situation. The 115 feet of Heat-Resistant Rope 1 will be pulled from it Storage Panel (not seen in this view) by the Fireman's weight and is sufficient length to allow a Fireman to safely descend a 10-story building or to at least escape a dangerous level down to a safer one. The KEVLAR Brake 3 allows the Fireman to slow or stop his descent to go into a lower level floor or window.

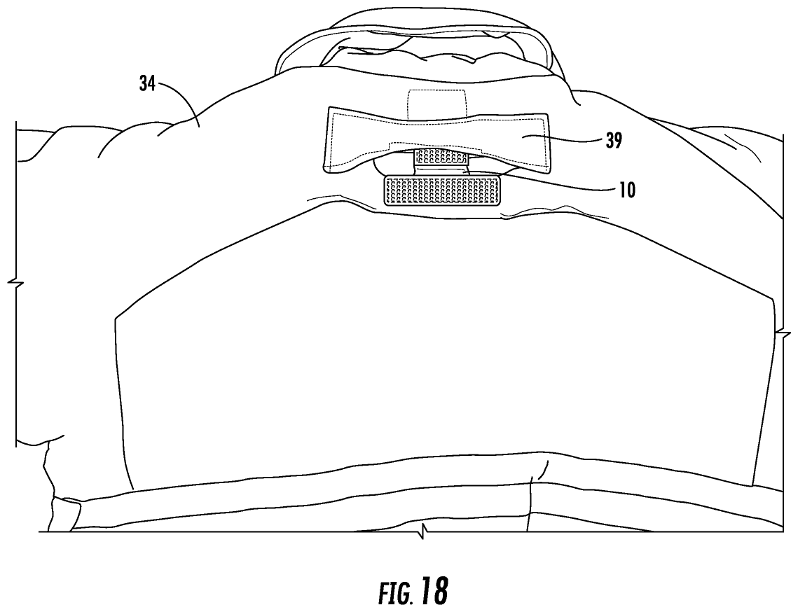

FIG. 18 shows the Emergency Drag Strap 10 Storage Location. The Exterior Flap 39 located on the upper back of the TG Coat 34 is shown pulled up from its attaching Velcro and the Emergency Drag Strap 10 can be seen in it Storage Location on the inside of the TG Coat 34. The Emergency Drag Strap 10 can be pulled out from its storage location to be used to remove an injured or unconscious Fireman to a safer location who is not able to walk.

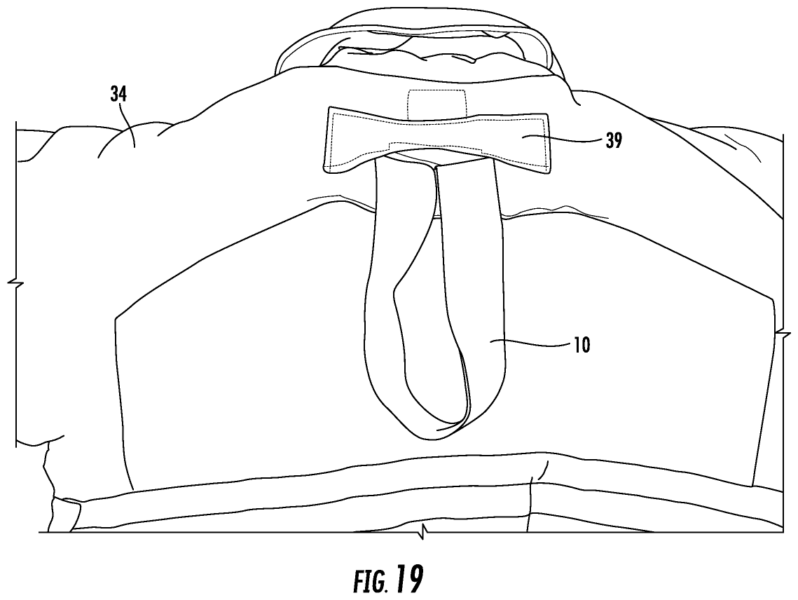

FIG. 19 shows the Emergency Drag Strap 10 removed from its storage location. Pulling on the strap, tightens the Arm Loops (not seen in this view) that are over the Fireman's Shoulders. The Emergency Drag Strap's Pull Point Fulcrum is the Center of the Fireman's Back. The harder the Drag Strap 10 is pulled, the tighter the Arm Loops will become over the injured Fireman's Shoulders, eliminating the possibility of the Emergency Drag Strap coming off of the injured Fireman or pulling the TG Coat up over the head or face of the injured Fireman. The Fireman's Body is being pulled, not his clothing or TG Coat.

While making clarifying changes to Applicant's preceding filing to address that examiner's Section 112 concerns, still other changes were made to better distance this invention from anything taught or suggested in the combination of the cited Jordan patent and Applicant's own '361 reference. The Examiner mistakenly characterized Jordan's descent “system” as being “full body” midway through page 5 of that Action. But this is far from true. The Jordan harness from 2002 either covers a turnout gear coat (his FIGS. 1, 7 and 8) OR pants (per his FIG. 2)—but not both! Even more distinctly, there was nothing disclosed in Jordan for connecting a firefighter's coat TO his/her pants via protective leg loops like that of the present invention.

The claims herein better underscore the critical protective nature of firefighting protective wear today. There MUST BE an outside (or exterior) fire-resistant shell—ALONG WITH a separate, insulating interior layer that cannot be punctured or otherwise compromised. This invention addresses a true two layered system—for BOTH coat and pants, in combination, with the harness elements of same running along the inside to the coat's outermost shell exterior . . . while NEVER impacting the highly protective, highly critical interior insulating liner found INSIDE both coat and pants legs. Jordan has NO leg straps and would NOT be approved for firefighter use by OSHA, or the NFPA today. Chest only harnesses like those shown in Jordan have been outlawed for years by OSHA, and not NFPA-certified for use by firemen either. They do not provide sufficient, full body protection.

In all views of the Jordan back-and-forth harness, support lines 20 wrap about the wearer's chest (or waist) horizontally—AND by greater than 75% about the circumference of said chest or waist! This invention, by sharp contrast, has a panel inside the rear wall of the wearer's outer coat that has a plurality of up-and-down unwinding line holders. Such an arrangement substantially reduces the risk of jamming when horizontally UNwinding all the way, back and forth, about the firefighter's whole chest (or waist) unlike the assigned harness body 18 of Jordan. In 2002, the main prior art (i.e., Jordan) taught a “vintage” harness that would've been useful for EITHER the firefighter's coat OR his/her pants—but NOT BOTH! No way should the teachings of this patent be bastardized to extend to the FULL BODY harness system of this invention—let alone one having an up-and-down, vertically extending unwind system from the back, inner wall to Applicant's panel—affixed to the inside of his outermost shell exterior. More importantly, nothing with the present system of rope UNwinding risks compromising the critical interior insulating liner(s) of Applicants system!

Further with respect to Jordan, it must be pointed out that its 2002 vintage “harness” employed standard carabiners 28, 30. Such devices would exhibit little to no frictional resistance to a rescue line unwinding therethrough. Applicant's control descent rack, by contrast, requires a purposeful threading pattern of descent line through its multiple apertures. They cause a natural frictional engagement to SLOW DOWN the unwinding of rescue line therethrough—so much so much that a safe, slowed descent may be accomplished even when lowering an unconscious firefighter to lower levels for rescue and recovery. The mere guidance of rescue line through one of Jordan's carabiners would be disastrous, if not fatal. Jordan's chest OR waist (pants) version would NOT allow an unconscious firefighter to be lowered without assistance from another. Jordan's carabiner configurations provide insufficient frictional drag to any line unspooling therethrough!

To further control speeds of descent, preferred embodiments of this invention employ friction braking handle means. When the wearer of Applicant's FULL BODY harness is secured to a fixture, he/she can safely slow down descent along the unwinding rescue line—or possibly even bring him or herself to a full stop if desired. Jordan has no such speed adjustment equivalents. The brake on such preferred embodiments can be applied with this coat-pants combination by gripping the brake handle and pulling down to either slow down or fully stop wearer descent.

Admittedly, some of the features of this invention were found in Applicant's earlier device, the subject of the '361 reference. But even that control descent system was limited to having a free-standing, triangularly-shaped back panel from which one or more extensions of safety line would “unspool”, horizontally, i.e., from side-to-side, rather than the preferred up-and-down line unwinding system accomplished by the rope panel of this invention that is permanently situated on the rear interior to Applicant's outer firefighter coat shell.

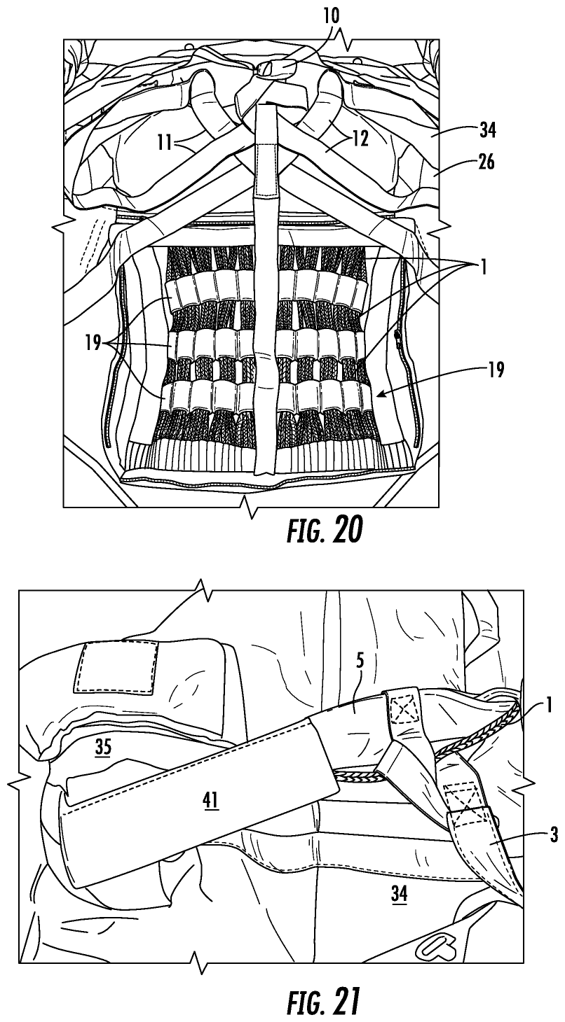

To better emphasize the patentable features of this system, four additional drawings/views are included herewith. In a first new view, FIG. 20, there is shown a firefighter's external (or outer) coat shell with its protective insulating inner liner lifted up and out of the way. In that way, one can better see the rope panel attached to the inner rear wall of the coat's outside shell. Note especially the up and down winding of flame resistant rope (or line) held by the plurality of horizontally extending line holders at both the top and bottom to this inner panel.

FIG. 21 focuses on one of the two outer shell coat pockets that, when lifted up, expose for extraction through that pocket one of the pair of chest straps that'll join to one another OUTSIDE the coat wearer's outer shell. Note how this one of two chest straps also has a portion of Applicant's preferred brake strap/handle visible along with a section of his control descent rack (at the far right edge—3 o'clock). Some segment of the flame resistant rope is carefully and purposefully directionally threaded through the apertures of that control descent rack.

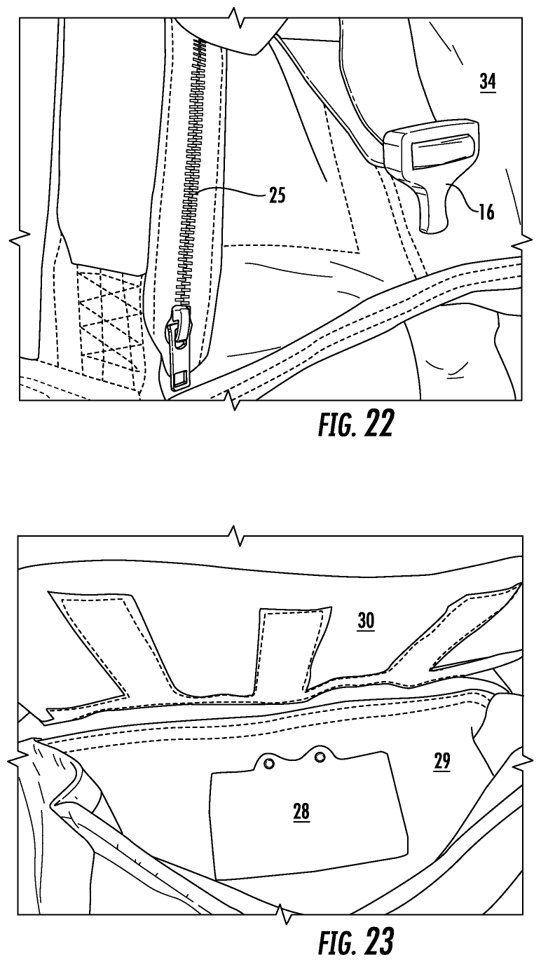

FIG. 22 shows the lower inner edge to one embodiment of coat panel with its exposed pants leg loop buckle dangling down from that lower inner edge at about 3 o'clock in the drawing. The leg loop buckle from the coat panel would mate/correspond to and/or match and then lock together with the corresponding leg loop buckle found in a pocket of the invention's firefighter pants leg until needed.

FIG. 23 “looks down” into one of two firefighter pants pockets with its cover flap raised for visibility purposes. At about the central most point of this picture, one can see the leg loop buckle bottom for mating/corresponding to and/or matching with (by snapping into place) with the coat's leg loop buckle “top” shown in FIG. 3. Together, the firefighter coat-and-pants combination create a true full body harness, emergency descent system unlike anything else ever seen in the art, or otherwise available for use by today's heroic firefighters to use in the event of an unforeseen, high rise rescue driven emergency situation.

### DRAWING ITEM NUMBERS

1—Heat-Resistant TECHNORA® brand Rope, 115 feet, ¼″, 8200 Tensile Strength
2—Controlled Descent Rack, 6061 T6 Forged Aluminum, Wood (Des. Pat. No. 684,845)
3—KEVLAR® Brake
4—Right Chest Strap Female Safety Buckle
5—Right Chest Strap
6—Right Leg Strap
7—Right Leg Strap Male Safety Buckle
8—Right Leg Loop Female Safety Buckle
9—Right Leg Loop
10—Emergency Drag Strap
11—Emergency Drag Strap Right Shoulder Loop
12—Emergency Drag Strap Left Shoulder Loop
13—Left Chest Strap
14—Left Chest Strap Male Safety Buckle
15—Left Leg Strap
16—Left Leg Strap Male Safety Buckle
17—Left Leg Loop Female Safety Buckle
18—Left Leg Loop
19—Rope Storage Panel of Heat-Resistant Elastic Loops that the Rope is pulled from, with zippers for attachment to Turnout Gear Coat. Rope is stored in vertical ribbon fashion top to bottom for secure placement and non-tangling deployment during a descent.
20—Right Female Safety Buckle, Storage Location of Right Leg Strap, Turnout Gear Coat
21—Right Shoulder Velcro attachment for Right Shoulder Loop of Emergency Drag Strap
22—Emergency Drag Strap Storage Velcro
23—Left Shoulder Velcro attachment for Left Shoulder Loop of Emergency Drag Strap
24—Left Female Safety Buckle, Storage Location of Left Leg Strap, Turnout Gear Coat
25—Rope Storage Panel Attachment Zippers on Turnout Gear Coat
26—Heat Protective Barrier Liner, Coat
27—Right Leg Loop Female Safety Buckle Slot into Side Pocket
28—Left Leg Loop Female Safety Buckle Slot into Side Pocket
29—Right Side Pocket, Pants
30—Flap for Right Side Pocket, Pants
31—Heat Protective Barrier Liner, Pants
32—Flap for Left Side Pocket, Pants
33—Left Side Pocket, Pants
34—Turnout Gear Coat
35—Right Upper Coat Pocket, Storage for Right Chest Strap, KEVLAR Sleeve, KEVLAR Brake, Controlled Descent Rack, Rope, and Female Safety Buckle
36—Left Upper Coat Pocket, Storage for Left Chest Strap and Male Safety Buckle
37—Right Coat Slot for Right Chest Strap entering Right Upper Coat Pocket (35)
38—Left Coat Slot for Left Chest Strap entering Left Upper Coat Pocket (36)
39—Emergency Drag Strap Flap, Coat
40—Turnout Gear Pants
41—KEVLAR Sleeve

While certain illustrative embodiments have been shown in the drawings and described above in considerable detail, it should be understood that there is no intention to limit the invention to the specific forms disclosed.

Having described the best modes currently known for practicing this axle replacement system and method, it is to be understood that the scope of this invention may be further described by the attached claims.

### SEQUENCE LISTING

Not applicable.

What is claimed is:

1. A full body emergency descent system for incorporating into a firefighter's coat and pants set, each of said firefighter's coat and said firefighter's pants from the coat and pants set including an exterior fire-resistant shell and an interior heat protective barrier liner, said emergency descent system adapted for: (i) attaching to an inside rear surface of the exterior fire-resistant shell of the firefighter's coat and; (ii) connecting the firefighter's coat to the firefighter's pants to create a full body harness made of an upper harness portion and a lower harness portion, said emergency descent system comprising:
a panel having a pair of chest straps, each of said pair of chest straps terminating in a chest strap buckle adapted for: (a) storing in a pocket in the exterior fire-resistant shell of the firefighter's coat until needed; (b) being pulled through said pocket when needed; and (c) coupling to one another about the exterior fire-resistant shell of the firefighter's coat to form the upper harness portion of the full body harness, said panel having a first set of a plurality of horizontally extending, elastic loops at an upper end of the panel and a second set of a plurality of horizontally extending, elastic loops at a lower end of the panel, said upper end elastic loops and said lower end elastic loops adapted for holding in a back-and-forth, vertically extending, continuously wound pattern a long section of flame resistant rope, said long section of flame resistant rope terminating at one end in an anchor adapted for securing to a building fixture that can support a firefighter's weight during a slow descent as the long section of flame resistant rope unwinds from the panel in a back-and-forth, up and down manner;
a pair of leg loops incorporated in the firefighter's pants outside the interior heat protective barrier liner of the firefighter's pants, each of the pair of leg loops having a leg loop buckle adapted for: (a) removing from a storage pocket in the firefighter's pants when needed; and (b) connecting to a mated leg strap buckle on a lower interior region of the firefighter's coat to form the lower harness portion of the full body harness; and
a control descent rack through which an end of the long section of flame resistant rope is threaded, said control descent rack adapted for making frictional contact with the long section of flame resistant rope as the long section of flame resistant rope unwinds from the panel during the firefighter's slow descent.

2. The emergency descent system of claim 1, which further includes a third set of a plurality of horizontally extending, elastic loops intermediate the first set of the plurality of horizontally extending, elastic loops at the upper end of the panel and the second set of the plurality of horizontally extending, elastic loops at the lower end of the panel.

3. The emergency descent system of claim 1, which further includes a brake strap through which the long section of flame resistant rope will pass when unwinding from the panel during the firefighter's slow descent, said brake adapted for being tugged on by the firefighter to slow or fully stop passage of the long section of flame resistant rope through the control descent rack.

4. The emergency descent system of claim 1 wherein the long section of flame resistant rope is at least 100 feet long.

5. The emergency descent system of claim 1 wherein the pair of chest strap buckles may be joined together by someone other than the firefighter wearing the firefighter's coat to assist in a rescue when the firefighter wearing the firefighter's coat is unconscious or incapacitated.

6. The emergency descent system of claim 1, which is designed for retrofitting in an existing firefighter's coat and pants set.

7. The emergency descent system of claim 1, which is designed for incorporating into a newly constructed firefighter's coat and pants set.

8. The emergency descent system of claim 1, which can be sized for use by an adult or teen weighing up to 375 lbs.

9. A full body emergency descent system for incorporating into a new or an existing firefighter's coat and pants set, each of said firefighter's coat and said firefighter's pants of the coat and pants set including an outside fire-resistant shell and an interior heat protective barrier liner that should not be punctured or compromised, said emergency descent system adapted for: (i) attaching to a back interior wall of the outside fire-resistant shell of the firefighter's coat and; (ii) buckling the firefighter's pants to a mated connector inside the firefighter's coat to create a two part, upper and lower full body harness, said emergency descent system comprising:
a panel having a pair of chest straps, each of said pair of chest straps terminating in a mated chest strap buckle adapted for connecting to each other after said pair of chest straps are removed from a storage pocket in the firefighter's coat and brought together for fastening about the outside fire-resistant shell of the firefighter's coat without compromising the protective interior heat protective barrier liner of the firefighter's coat to form the upper full body harness for the full body emergency descent system, said panel also having a first set of a plurality of horizontally extending, heat resistant elastic loops at or near a top end of the panel, a second set of a plurality of horizontally extending, heat resistant elastic loops at or near a bottom end of the panel and at least one additional set of a plurality of horizontally extending, heat resistant elastic loops intermediate: the first set of the plurality of horizontally extending, heat resistant elastic loops at or near the top end of the panel and the second set of the plurality of horizontally extending, heat resistant elastic loops at or near the bottom end of the panel, said first, second and at least one additional set of the plurality of horizontally extending, heat resistant elastic loops all being adapted for holding in a back-and-forth, substantially vertically extending pattern a wound section of elongated flame resistant rope, said elongated flame resistant rope securing to the panel at a first end and having a second end adapted for: (i) anchoring, directly or indirectly, to a fixture capable of supporting a descending firefighter's weight; and (ii) effecting a slow descent by the firefighter in an emergency situation;
a pair of leg loops, a first leg loop incorporated into a first leg of the firefighter pants outside the protective internal liner to said firefighter pants and a second leg loop incorporated into a second leg of the firefighter pants outside the protective internal liner to said firefighter pants, each leg loop including a buckle at one end designed for connecting to a corresponding buckle at or near a lower region of the firefighter coat to form, when connected, a lower portion of the full body harness;
a control descent rack having a plurality of apertures through which one end of said elongated flame resistant rope is threaded in a predetermined pattern for slowing down by frictional contact how fast the elongated flame resistant rope unwinds from the panel during an emergency controlled descent; and
a friction braking handle for use by the firefighter wearing the firefighter's coat to: (i) further slow how fast the elongated flame resistant rope passes through the control descent rack; or (ii) fully stop the elongated flame resistant rope from passing through the control descent rack.

10. The emergency descent system of claim 9, which includes at least 75 feet of the elongated flame resistant rope.

11. The emergency descent system of claim 9 wherein the panel further includes a drag strap loop designed for accessing through an aperture in an exterior neck region of the firefighter's coat.

12. The emergency descent system of claim 9, which can be sized for use by an adult or a teen.

13. The emergency descent system of claim 9, which is designed for retrofitting in an existing firefighter's coat and pants set.

14. The emergency descent system of claim 9, which is designed for incorporating into a newly constructed firefighter's coat and pants set.

15. A full body emergency descent system for retrofitting to an existing firefighter's coat and pants set, each of said firefighter's coat and said firefighter's pants of the coat and pants set having an outside fire-resistant shell and an interior heat protective barrier liner, said emergency descent system adapted for: (i) attaching to an inner back wall of the outside fire-resistant shell of the firefighter's coat and; (ii) connecting the firefighter's pants to the firefighter's coat when needed in an emergency to create a full body harness, said emergency descent system comprising:
a panel having a pair of chest straps, each of said pair of chest straps: (a) extending about an interior to the outside fire-resistant shell of the firefighter's coat without penetrating the interior heat protective barrier liner to said firefighter's coat; and (b) terminating in a mated chest strap buckle adapted for joining together after said pair of chest straps are removed from a storage pocket in the firefighter's coat and wrapped about the outside fire-resistant shell of the firefighter's coat to form an upper portion of the full body harness of the emergency descent system, said panel having two or more rows of a plurality of horizontally extending, elastic loops adapted for holding in a back-and-forth, vertically extending pattern at least 75 feet of continuous flame resistant rope, said continuous flame resistant rope having a first end secured to the panel and a second end adapted for anchoring to a building fixture for enabling a controlled slow descent by the firefighter wearing the emergency descent system;
a left leg loop and a right leg loop, each leg loop designed for incorporating into respective legs of the firefighter's pants outside the insulating protective liner, each leg loop having a buckle at one end for connecting to a corresponding buckle on a lower interior end of the firefighter's coat thus forming a lower portion of the full body harness;
a control descent rack having a plurality of apertures through which said continuous flame resistant rope is threaded and through which the continuous flame resistant rope will slowly unwind due, in part, to frictional contact with the control descent rack during use of the emergency descent system; and
a friction braking handle for use by the firefighter wearing the emergency descent system to slow down the continuous flame resistant rope as it passes through the control descent rack or at least temporarily stop the continuous flame resistant rope from passing through the control descent rack during a controlled descent.

16. The emergency descent system of claim 15 which includes at least 100 feet of flame resistant rope.
